(19) United States
(12) Patent Application Publication
(10) Pub. No.: US 2018/0007480 A1
(43) Pub. Date: Jan. 4, 2018

(54) Patrol vehicle communications system

(71) Applicant: Michael D. Dieringer, Rolling Hills, CA (US)

(72) Inventor: Michael D. Dieringer, Rolling Hills, CA (US)

(21) Appl. No.: 15/731,252

(22) Filed: May 10, 2017

Related U.S. Application Data
(60) Provisional application No. 62/392,070, filed on May 19, 2016.

(51) Int. Cl. H04R 27/00; B60R 11/00; H04B 1/3822; H04W 4/10

(52) U.S. Cl. CPC H04R 27/00; H04B 1/3822; B60R 11/00; B60R 2011/001; H04R 2430/01; H04W 4/10

(57) ABSTRACT

A communications system for use by an individual having access to a vehicle and one of a vehicle-mounted two-way mobile radio, a portable two-way radio and a vehicle-mounted public address (PA) system utilizes push-to-talk (PTT) switches and volume control arrangements which are mounted within the steering wheel of the vehicle so that the individual can operate the PTT switches and the volume control arrangements with one hand while both of his hands remain positioned about the steering wheel. In addition, microphones which are associated with the mobile radio, portable radio and the PA system are mounted along the headliner of the vehicle cabin.

The benefit of Provisional Application Ser. No. 62/392,070, filed May 19, 2016 and entitled PATROL VEHICLE COMMUNICATIONS SYSTEM, is hereby claimed. The disclosure of this referenced provisional application is incorporated herein by reference.

### BACKGROUND OF THE INVENTION

This invention relates generally to communications equipment through which an individual, such as a law enforcement officer, can communicate from a vehicle, such as a patrol car, and relates, more particularly, to means and methods by which various operating characteristics of such communications equipment can be adjusted by the individual while the individual is driving the vehicle.

The class of communications equipment with which this invention is concerned includes any of (or combinations of) the following three items: a vehicle-mounted two-way mobile radio, a vehicle-mounted siren public address (PA) system, and a body-mounted two-way portable radio. At least two, and sometimes all, of these items are likely to be accessible to an individual, such as a law enforcement officer, for communication purposes while the individual is driving his vehicle.

Heretofore, each of the aforementioned three items has required physical interaction with appropriate controls of the item in order for the individual to use or operate the item in its intended manner. For example, each of the vehicle-mounted two-way mobile radio and the vehicle-mounted public address (PA) system commonly possesses a handmic which includes a microphone which is mounted, or attached, substantially centrally of the vehicle console and which includes a momentary push-to-talk (PTT) switch which, when actuated or depressed, readies the item for the transmission of voice messages (i.e. talk) spoken by the individual into the microphone of the handmic. Moreover, the handmic of the mobile radio and the PA system must be brought into relatively close proximity to the individual's mouth (e.g. within about one inch) in order that the microphone of the handmic effectively pick up what the individual is saying. Further still, the receive, or “listen” audio volume of the mobile radio is commonly adjustable by way of a volume control dial mounted on the main body of the radio itself. Meanwhile, the audio (i.e. speaker) volume of the mobile radio, as well as that of the portable radio, is commonly adjustable by way of a volume control dial mounted on the main body of the radio.

By comparison, a body-mounted two-way portable radio commonly includes a speakermic accessory which is typically affixed to the lapel area of the individual's clothing, and the speakermic includes a momentary push-to-talk (PTT) switch which, when depressed, readies the portable radio for receiving voice messages spoken by the individual into his speakermic for subsequent transmission to a remote site. Again, the receive, or “listen”, audio volume of the portable radio is commonly adjustable by way of a volume control dial mounted on the body of the portable radio.

A characteristic shared by each of the three aforementioned items is that the PTT switches and the volume control dials of the items must be manipulated by a hand of the individual who is using the item. Consequently, when the individual is driving his vehicle (with two hands grasped about the steering wheel), one hand must leave the steering wheel in order to manipulate the aforementioned PTT switches or volume control dials or to hold the handmic adjacent the individual's mouth for purposes of speaking into the handmic. However, some driving situations involve a high-speed chase, and to remove one hand from the steering wheel (thus leaving the steering operation to one hand) could be extremely dangerous.

It would be desirable to provide a communications system which involves any of the aforementioned three communications items or combinations thereof whose PTT switches and volume controls can be actuated by the individual while the user's hands remain positioned about the steering wheel of the vehicle. It would also be desirable to provide such a communications system whose microphone need not be held by a hand of the individual while voice messages are spoken into the microphone so that both hands of the individual who is driving his vehicle can remain about the steering wheel while the microphone is used.

Accordingly, it is an object of the present invention to provide a new and improved communications system for use by an individual which permits the individual to communicate from his vehicle by way of a vehicle-mounted mobile two-way radio, a portable two-way radio or a vehicle-mounted public address (PA) system while both hands of the individual remain grasped about the steering wheel of the vehicle.

Another object of the present invention is to provide such a communications system whose PTT switches and volume controls are accessible on the steering wheel of the vehicle.

Still another object of the present invention is to provide such a communications system which involves a mobile radio and a PA system whose microphones are mounted along the headliner of the cabin of the vehicle being operated by the individual.

Yet another object of the present invention is to provide such a communication system which is uncomplicated in structure, yet effective in operation.

### SUMMARY OF THE INVENTION

This invention resides in a communications system for use by an individual having access to a vehicle and one of a vehicle-mounted two-way mobile radio, a portable two-way radio and a vehicle-mounted siren public address (PA) system wherein each of the vehicle-mounted two-way mobile radio and the portable two-way radio is switchable from a non-talk mode to a talk mode upon actuation of an associated push-to-talk (PTT) switch and the PA system is rendered capable of broadcasting voice messages spoken into a microphone associated with the PA system upon actuation of an associated push-to-talk (PTT) switch and wherein the vehicle includes a steering wheel.

The improvement is characterized in that the push-to-talk (PTT) switch associated with the one of the mobile radio, the portable radio and the PA system is mounted within the steering wheel of the vehicle and is adapted to switch the one of the mobile radio and the portable radio from a non-talk mode to a talk mode upon actuation of the PTT switch or renders the PA system capable of broadcasting voice messages spoken into a microphone associated with the PA system upon actuation of the PTT switch so that the individual can actuate the PTT switch associated with the one of the mobile radio, the portable radio or the PA system with one of his two hands while the one hand remains positioned about the steering wheel.

In one embodiment of the communications system, the one of the mobile radio, the portable radio and the PA system includes volume control capabilities having a hand-operable volume control arrangement which, when manipulated with one hand of the individual, adjusts the volume of the one of the mobile radio, the portable radio and the PA system, and the improvement in this one embodiment is characterized in that the volume control arrangement is mounted within the steering wheel of the vehicle so that the individual can manipulate the volume control arrangement with one of his two hands while both of his hands remains positioned about the steering wheel.

In still one more embodiment of the communications system, the vehicle includes a cabin compartment having a headliner and there is associated with the one of the mobile radio, the portable radio and the PA system a microphone into which the individual speaks when using the one of the mobile radio, the portable radio, and the PA system. The improvement in this one more embodiment is characterized in that the microphone is mounted along the headliner of the cabin compartment of the vehicle.

### BRIEF DESCRIPTION OF THE DRAWINGS

FIG. 1 is a view illustrating schematically an exemplary environment of intended use of a communications system in which features of the present invention are embodied.

FIG. 2 is an elevational view of a portion of the interior of the cabin of a vehicle of the FIG. 1 environment and various components of the FIG. 1 communications system.

FIG. 3 is a view illustrating in block diagram form the operation of the vehicle-mounted two-way mobile radio system of the FIG. 1 communications system.

FIG. 4 is a view illustrating in block diagram form the operation of the vehicle-mounted siren public address (PA) system of the FIG. 1 communications system.

FIG. 5 is a view illustrating in block diagram form the operation of the portable two-way radio system of the FIG. 1 communications system.

### DETAILED DESCRIPTION OF AN ILLUSTRATIVE EMBODIMENT

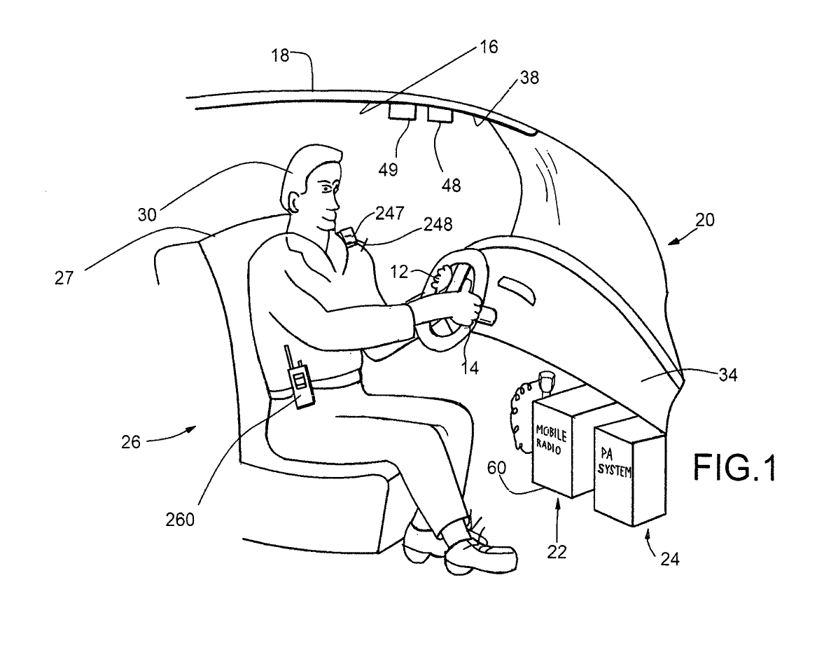

Turning now to the drawings in greater detail and considering first FIG. 1, there is schematically illustrated an embodiment, generally indicated 20, of a communications system within which features of the present invention are embodied and shown utilized in an exemplary environment of intended use. The communications system 20 includes a vehicle-mounted mobile two-way radio system 22 whose components are mounted entirely within the body of a vehicle 18, a vehicle-mounted siren public address (PA) system 24 whose components are also mounted entirely within the body of the vehicle 18, and a portable two-way radio system 26 whose components are worn upon the person of an individual 30, such as a law enforcement officer, who is seated in the driver's seat 27 of the vehicle 18.

As will be apparent herein, the communications system 20 includes componentry which is mounted within the interior of the cabin, indicated 16, of the vehicle 18 and includes easily-accessible controls, described herein, which enable the individual 30 to control the operation of the various systems, or items, 22, 24 and 26 without having to remove either of his two hands, indicated 12 and 14 in FIG. 1, from the steering wheel 32 of the vehicle 18.

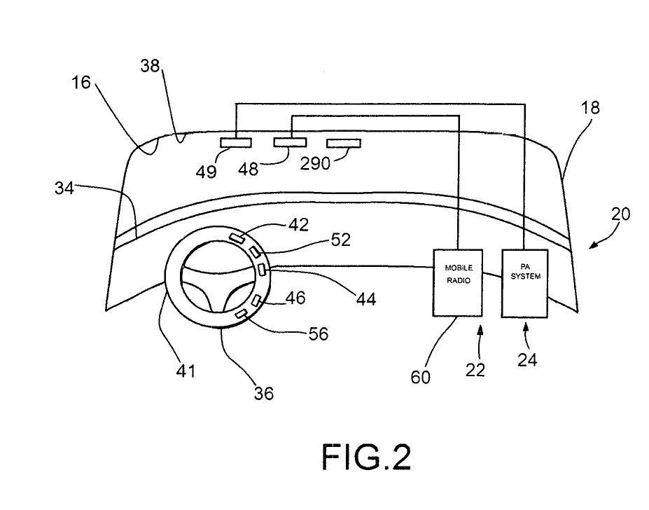

With reference to FIG. 2, there is illustrated a schematic view of the interior of the cabin 16 of the vehicle 18 depicting the dashboard 34, the steering wheel 36 and the headliner 38. Associated with the steering wheel 36 is a rim 41 adapted to be grasped by both (i.e. two) hands of the individual 30 while the individual 30 operates and steers the vehicle 18. In addition, the aforementioned easily-accessible controls include three actuatable (i.e. two-position) push-to-talk (PTT) switches 42, 44 and 46 which are mounted along the rim 41 of the steering wheel 36 for a purpose which will be apparent herein and two volume control (i.e. toggle) arrangements 52 and 56 whose purpose will also be apparent herein. Each of the switches or arrangements 42, 44, 46, 52, and 56 is advantageously disposed along the rim 41 of the steering wheel 34 so that any of these switches can be manipulated with the thumb of one (e.g. the right hand) of the individual 30 as both hands 12 and 14 of the individual 30 remain positioned (i.e. grasped) about the steering wheel 36 for purposes of steering the vehicle 18.

In addition, two microphones 48 and 49 are fixedly mounted along the headliner 38 of the vehicle cabin 16; and one microphone 48 is wired within the mobile radio system 22 and the other microphone 44 is wired within the PA system 24, respectively. The microphones 48 and 49 are disposed close enough to the mouth of the individual 30 (when the individual 30 is seated in the driver's seat of the vehicle 18) so that the microphones 48 and 49 effectively pick up the voice messages spoken by the individual 30, and thus obviate the need for a hand-held handmic when using either the mobile radio 22 or the PA system 24.

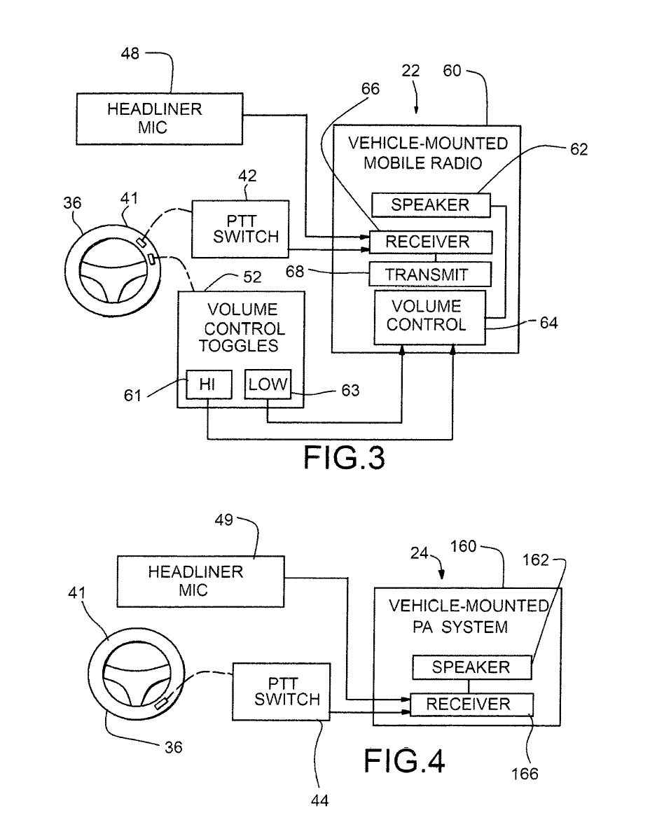

The structure and operation of the vehicle-mounted mobile two-way radio 22 can be best understood with reference to the block diagram of FIG. 3. In particular, the mobile radio system 22 includes a main body 60 which is mounted within the vehicle cabin 16 (e.g. behind the dashboard 34 thereof) and further includes the headliner-mounted microphone 48, introduced earlier. The major components and operating characteristics of the mobile radio 22 are well-known so that a detailed description thereof is not believed to be necessary. Suffice it to say that the mobile radio 22 is capable of being switched between a “talk” mode and a “non-talk” (i.e. a “speaker”) mode as a push-to-talk (PTT) switch is actuated. In particular and unless the PTT switch is actuated, or depressed, the mobile radio 22 remains in a “non-talk” mode so that its components are in condition for accepting wirelessly-transmitted messages sent to the individual 30 from a remote source for conductance to a speaker 62 through which the individual 30 can hear the accepted messages. However, when a PTT switch is actuated, the mobile radio 22 reverts to a condition for receiving messages spoken into the microphone 48 by the individual 30. The mobile radio 22 also includes volume control componentry, or a volume controller 64, enabling the adjustment (higher versus lower) of the volume (i.e. the speaker volume) of the mobile radio 22.

It is a feature of the mobile radio 22 of the communications system 20 that it includes the PTT switch 42, introduced earlier, which is mounted within the rim 41 of the steering wheel 34 and which is wired to the body 60 of the radio 22 so that upon depression of the PTT switch 42, the radio 22 is switched from its non-talk mode to its talk mode. In addition, the microphone 48 is wired to the radio body 60 so that upon switching the radio 22 to its talk mode, the componentry of the radio body 60 accepts voice messages spoken into the microphone 48 by the individual 30 for (wireless) transmission to a remote site by way of a transmitter 68. In this regard, the radio 22 includes a receiver 66 for receiving the switching signal from the PTT switch 42, when actuated, and enables the receipt of voice messages spoken by the individual 30 by way of the microphone 48.

In addition, there is mounted within the radio body 60 the volume controller 64, introduced earlier, for controlling the volume of the receive, or “listen” audio signals received from a remote source and emitted from the speaker 62 for the individual 30 to hear. Meanwhile, the volume control (toggle) arrangement 52 mounted within the steering wheel 36 includes a high volume (i.e. a volume increasing) switch 61 connected to the radio body 60 for transmitting (by way of the volume controller 64) a command signal that the audio volume of the radio 22 be increased and a low volume (i.e. a volume decreasing) switch 63 connected to the radio body 60 for transmitting (by way of the volume controller 64) a command signal that the audio volume of the mobile radio 22 be decreased.

It follows that during use of the mobile radio 22 by the individual 30 seated in the driver's seat and behind the steering wheel 36, the PTT switch 42 and the volume control (toggle) arrangement 52 are accessible with the thumb of one hand 14 (e.g. the right hand) of the two hands 12, 14 of the individual 30 enabling the individual 30 to operate the mobile radio 22 (i.e. switch the mobile radio 22 to a talk mode or adjust the audio volume of the radio 22) while both of the individual's hands 12, 14 remain grasped about the steering wheel 36. Therefore and in a situation which requires the individual 30 to utilize the mobile radio 22 while driving the vehicle 18 at a high rate of speed, the individual 30 need not let go of the steering wheel 36 with either hand 12 or 14 in order to control the operation of the mobile radio 22.

The structure and operation of the vehicle-mounted siren public address (PA) system 24 can be best understood with reference to the block diagram of FIG. 4. In particular, the PA system 24 includes a main body 160 which is mounted within the vehicle cabin 16 (e.g. behind the dashboard 34 thereof) and further includes the microphone 49, introduced earlier, mounted along the headliner 38 of the vehicle cabin 16. The major components and operating characteristics of the PA system 24 are well-known so that a detailed description thereof is not believed to be necessary. Suffice it to say that the PA system 24 is capable of being utilized in a talk or “speaker” mode when an appropriate push-to-talk (PTT) switch is actuated. In particular and unless the PTT switch is actuated, or depressed, the PA system 24 remains in a dormant state so that so that its components do not accept or transmit voice messages spoken into the microphone 49 of the PA system 24. However, when an appropriate PTT switch is actuated, the PA system 24 reverts (from a dormant state) to its “speaker” mode and is able to broadcast messages spoken into the microphone 49 by way of a speaker 162.

It is a feature of the PA system 24 of the communications system 20 that it includes the PTT switch 44, introduced earlier, which is mounted within the rim 41 of the steering wheel 36 and which is wired to the body 160 of the PA system 24 so that upon depression of the PTT switch 44, the PA system 24 is switched to its “speaker” mode. In addition, the microphone 49 is wired to the PA system body 160 so that upon switching the PA system 24 into its “speaker” mode, the componentry of the PA system body 160 accepts voice messages spoken into the microphone 48 by the individual 30 for broadcast from the vehicle 18 as audible voice messages by way of the speaker 162. In this regard, the PA system 24 includes a receiver 166 for receiving the switching signal from the PTT switch 44, when actuated, and enables the receipt of voice messages spoken by the individual 30 by way of the microphone 49 for transmission to the speaker 166.

It follows that during use of the PA system 24 by the individual 30 seated behind the steering wheel 36, the PTT switch 52 is accessible with the thumb of one hand 14 (e.g. the right hand) of the individual 30 enabling the individual 30 to operate the PA system 24 (i.e. switch the PA system 24 to a “speaker” mode while both of the individual's hands 12, 14 remain grasped about the steering wheel 36. Therefore and in a situation which requires the individual 30 to utilize the PA system 24 while the vehicle 18 is being driven at a high rate of speed and both of the individual's hands 12, 14 are grasped about the steering wheel 36, the individual 30 need not let go of the steering wheel 36 with either hand 12 or 14 in order to control the operation of the PA system 24.

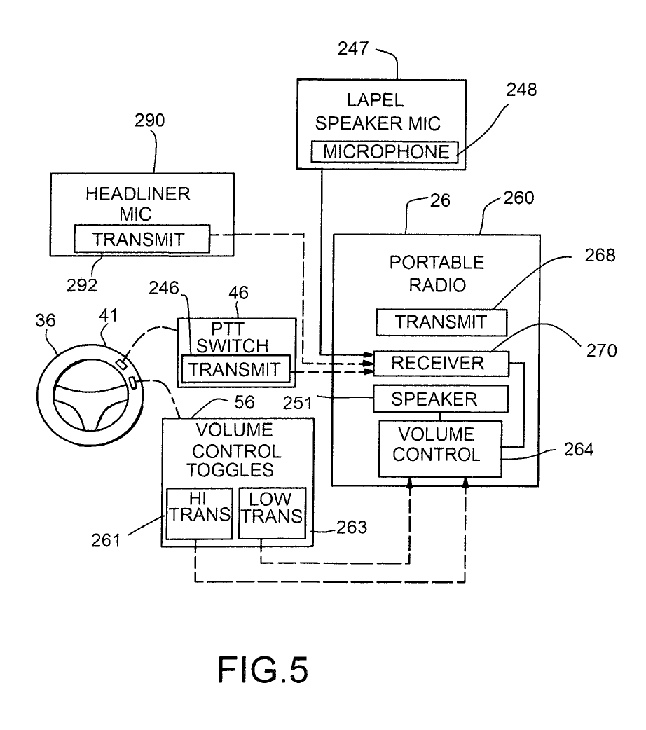

The structure and operation of the portable two-way radio 26 can be best understood with reference to the block diagram of FIG. 5. In particular, the portable radio 26 includes a body 260 which is attached near the waist, or along the belt, of the individual 30 and further includes a speakermic 247 including a microphone 248 which is worn upon the lapel of the individual 30 (as best shown in FIG. 1). The major components and operating characteristics of the portable radio 26 are well-known so that a detailed description thereof is not believed to be necessary. Suffice it to say that the portable radio 26 is capable of being switched between a “talk” mode and a “non-talk” mode as an appropriate push-to-talk (PTT) switch is actuated. In particular and unless the PTT switch is actuated, or depressed, the portable radio 22 remains in a “non-talk” mode so that its components are in condition for accepting wirelessly-transmitted messages sent to the individual 30 from a remote source for conductance to a speaker 251 (mounted in the portable radio body 260 as depicted in FIG. 5) through which the individual 30 can hear the messages received by the portable radio 26. However, when the appropriate PTT switch is actuated, the portable radio 26 reverts to a condition for receiving messages spoken into the microphone 248 of the speakermic 247 for wireless transmission to a remote site by way of a transmitter 268. The portable radio 26 also includes a volume controller 264 enabling the adjustment (higher versus lower) of the volume of the portable radio 22.

It is a feature of the portable radio 26 of the communications system 20 that it includes the PTT switch 46, introduced earlier, which is mounted within the rim 41 of the steering wheel 34 and which includes a transmitter 246 so that upon depression of the PTT switch 46, a signal is wirelessly transmitted from the transmitter 246 which signal indicates that the PTT switch 46 has been actuated, or depressed. In connection with the foregoing, the body 260 of the portable radio 26 includes a receiver 270 for receiving the signal transmitted from the transmitter 246 for switching the portable radio 26 to its talk mode. Therefore and upon receipt of the switching signal from the PTT switch 46 (by way of the transmitter 246), the receiver 270 switches the portable radio 26 to a talk mode so that voice messages which are spoken into the microphone 248 of the speakermic 247 by the individual 30 are transmitted (wirelessly) from the radio body 260 to a remote site.

In addition, there is mounted within the portable radio body 260 the volume controller 264, introduced earlier, for controlling the volume of the audio voice messages received from a remote site and emitted from the speaker 251. Meanwhile, the volume control (toggle) arrangement 56 mounted within the steering wheel 36 includes a high volume (i.e. a volume increasing) switch 261 connected to the portable radio body 260 for transmitting (by way of the volume controller 264) a command signal that the volume of the portable radio 26 be increased and a low volume (i.e. a volume decreasing) switch 263 connected to the portable radio body 260 for transmitting (by way of the audio volume controller 264) a command signal that the volume of the portable radio 26 be decreased.

As an alternative to requiring that the individual 30 speak into his lapel-mounted speakermic 247, an additional microphone 290 can be mounted along the headliner 38 (FIG. 2) adjacent the aforedescribed microphone 48 and 49 which, when activated, provides the individual 30 with the capacity to speak into the headliner-mounted microphone 290 for subsequent (wireless) transmission of those spoken messages to the body 260 of the portable radio 26 for transmission (wirelessly) to a remote site. To this end, there is associated with the headliner-mounted microphone 290 a transmitter 272 for wirelessly transmitting voice-carrying signals to the body 260 of the portable radio 26 where they are received by way of the receiver 270.

It follows that during use of the portable radio 26 by the individual 30 seated behind the steering wheel 36 of the vehicle 18, the PTT switch 46 and the volume control (toggle) arrangement 56 are accessible with the thumb of one hand 14 (e.g. the right hand) of the individual 30 in order to operate the portable radio 26 (i.e. switching the portable radio 26 to a talk mode, as necessary, or adjusting the audio volume of the portable radio 26, as necessary) while both of the individual's hands 12, 14 remain grasped about, or in contact with, the steering wheel 36. Therefore and in a situation which requires the individual 30 to utilize the portable radio 26 while the vehicle 18 is being driven at a high rate of speed, the individual 30 need not let go of the steering wheel 36 with either hand 12 or 14 in order to control the operation of the portable radio 26.

It will be understood that numerous modifications and substitutions can be had to the aforedescribed embodiment 20 without departing from the spirit of the invention. For example, although the aforedescribed systems, or items, 22, 24 and 26 of the communications system 20 have been shown and described as being combined within a single embodiment 20, it will be understood that a communications system in accordance with the principles of the present invention can be shown and described as including any one or two of the aforedescribed items 22, 24 and 26.

Further still and in accordance with the principles of the present invention, a single volume control (e.g. toggle) arrangement can be connected to both the volume controller 64 of the mobile radio 22 and the volume controller 264 of the portable radio 22 so that the audio volume of both of the mobile radio 22 and the portable radio 22 can be controlled by way of a single volume control (e.g. toggle) arrangement.

Accordingly, the aforedescribed embodiment 20 is intended for the purpose of illustration and not as limitation.

1. In a communications system for use by an individual having access to a vehicle and one of a vehicle-mounted two-way mobile radio, a portable two-way radio and a vehicle-mounted siren public address (PA) system wherein each of the vehicle-mounted two-way mobile radio and the portable two-way radio is switchable from a non-talk mode to a talk mode upon actuation of an associated push-to-talk (PTT) switch and the PA system is rendered capable of broadcasting voice messages spoken into a microphone associated with the PA system upon actuation of an associated push-to-talk (PTT) switch and wherein the vehicle includes a steering wheel, the improvement characterized in that:
the push-to-talk (PTT) switch associated with the one of the mobile radio, the portable radio and the PA system is mounted within the steering wheel of the vehicle and is adapted to switch the one of the mobile radio and the portable radio from a non-talk mode to a talk mode upon actuation of the PTT switch or renders the PA system capable of broadcasting voice messages spoken into a microphone associated with the PA system upon actuation of the PTT switch so that the individual can actuate the PTT switch associated with the one of the mobile radio, the portable radio or the PA system with one hand while both of his hands remain positioned about the steering wheel.

2. The improvement as defined in claim 1 wherein the one of the mobile radio and the portable radio includes volume control capabilities having a hand-operable volume control arrangement which, when manipulated with a hand of the individual, adjusts the volume of the one of the mobile radio and the portable radio, and the improvement is further characterized in that:
the volume control arrangement is mounted within the steering wheel of the vehicle so that the individual can manipulate the volume control arrangement with one hand while both of his hands remain positioned about the steering wheel.

3. The improvement as defined in claim 2 wherein the volume control arrangement includes a low volume switch which is operable between one condition at which no effect is had on the volume of the one of the mobile radio and the portable radio and another condition at which the volume of the one of the mobile radio and the portable radio is lowered;
the volume control arrangement further includes a high volume switch which is operable between one condition at which no effect is had on the volume of the one of the mobile radio the portable radio and another condition at which the volume of the one of the mobile radio and the portable radio is raised; and
the one of the mobile radio and the portable radio includes a receiver through which the condition of the low volume switch and the condition of the high volume switch are detected.

4. The improvement as defined in claim 1 wherein the one of the vehicle-mounted two-way mobile radio, the portable two-way radio and the vehicle-mounted siren public address (PA) system is the two-way mobile radio, and
the PTT switch is operable between one condition which corresponds to the non-talk mode of the two-way mobile radio and another condition which corresponds to the non-talk mode of the two-way mobile radio, and
the two-way mobile radio includes a receiver through which the condition of the PTT switch is detected.

5. The improvement as defined in claim 1 wherein the one of the vehicle-mounted two-way mobile radio, the portable two-way radio and the vehicle-mounted siren public address (PA) system is the portable two-way radio, and
the PTT switch is operable between one condition which corresponds to the non-talk mode of the portable two-way mobile radio and another condition which corresponds to the non-talk mode of the portable two-way mobile radio, and
the portable two-way mobile radio includes a receiver through which the condition of the PTT switch is detected.

6. The improvement as defined in claim 1 wherein the one of the vehicle-mounted two-way mobile radio, the portable two-way radio and the vehicle-mounted siren public address (PA) system is the PA system, and
the PTT switch is operable between one condition which corresponds to a dormant state of the PA system and another condition which corresponds to a speaker mode of the PA system, and
the PA system includes a receiver through which the condition of the PTT switch is detected.

7. The improvement as defined in claim 1 wherein the vehicle includes a cabin compartment having a headliner, and there is associated with the one of the mobile radio, the portable radio and the PA system a microphone into which the individual speaks when using the one of the mobile radio and the portable radio in the talk mode or the PA system when rendered capable of broadcasting voice messages, and the improvement is further characterized in that the microphone is mounted along the headliner of the cabin compartment of the vehicle.

8. In a communications system for use by an individual having access to a vehicle and a vehicle-mounted two-way mobile radio and the vehicle-mounted two-way mobile radio is switchable from a non-talk mode to a talk mode upon actuation of an associated push-to-talk (PTT) switch and wherein the vehicle includes a steering wheel, the improvement characterized in that:
the push-to-talk (PTT) switch associated with the mobile radio is mounted within the steering wheel of the vehicle and is adapted to switch the mobile radio from a non-talk mode to a talk mode upon actuation of the PTT switch so that the individual can actuate the PTT switch associated with the mobile radio with one hand while both of his hands remain positioned about the steering wheel;
the two-way mobile radio includes a body which is mounted within the cabin compartment of the vehicle; and
the PPT switch which is mounted in the steering wheel is connected to the body of the mobile radio by way of a wire.

9. The improvement as defined in claim 8 wherein the mobile radio includes volume control capabilities having a hand-operable volume control arrangement which, when manipulated with one hand of the individual, adjusts the volume of the mobile radio, and the improvement is further characterized in that:
the volume control arrangement is mounted within the steering wheel of the vehicle so that the individual can manipulate the volume control arrangement with one hand while both of his hands remain positioned about the steering wheel.

10. In a communications system for use by an individual having access to a vehicle and a vehicle-mounted siren public address (PA) system and the PA system is switchable from a dormant state to a speaker mode upon actuation of an associated push-to-talk (PTT) switch and wherein the vehicle includes a steering wheel, the improvement characterized in that:
the push-to-talk (PTT) switch associated with the PA system is mounted within the steering wheel of the vehicle and is adapted to switch the PA system from a dormant state to a speaker mode upon actuation of the PTT switch so that the individual can actuate the PTT switch associated with the PA system with one hand while both of his hands remain positioned about the steering wheel;
the PA system includes a body which is mounted within the vehicle; and
the PPT switch which is mounted in the steering wheel is connected to the body of the PA system by way of a wire.

11. In a communications system for use by an individual having access to a vehicle and a portable two-way radio wherein the portable two-way radio is switchable from a non-talk mode to a talk mode upon actuation of an associated push-to-talk (PTT) switch and wherein the vehicle includes and a steering wheel, the improvement characterized in that:
the push-to-talk (PTT) switch associated with the portable radio is mounted within the steering wheel of the vehicle and is adapted to switch the portable radio from a non-talk mode to a talk mode upon actuation of the PTT switch so that the individual can actuate the PTT switch associated with the portable radio with one hand while both of his hands remain positioned about the steering wheel.

12. The improvement as defined in claim 11 wherein the portable radio has a body which is mounted upon the individual;
the PTT switch is operable between one condition which corresponds to the non-talk mode of the portable two-way radio and another condition which corresponds to the non-talk mode of the portable two-way mobile radio, and
the portable two-way radio includes a receiver through which the condition of the PTT switch is detected.

13. The improvement as defined in claim 12 wherein there is associated with the PTT switch a transmitter for wirelessly transmitting the condition of the PTT switch; and
the body of the portable two-way radio includes a receiver for receiving the wireless transmission of the condition of the PPT switch.

14. The improvement as defined in claim 11 wherein the portable radio includes volume control capabilities having a hand-operable volume control arrangement which, when manipulated with a hand of the individual, adjusts the volume of the portable radio,
wherein the portable radio has a body which is mounted upon the individual; and
wherein the volume control arrangement includes a low volume switch which is operable between one condition at which no effect is had on the volume of the portable radio and another condition at which the volume of the portable radio is lowered;
the volume control arrangement further includes a high volume switch which is operable between one condition at which no effect is had on the volume of the portable radio and another condition at which the volume of the portable radio is raised; and
the body of the portable radio includes a volume controller through which the condition of the low volume switch and the condition of the high volume switch are detected.

15. The improvement as defined in claim 14 wherein the condition of the high volume switch and the condition of the low volume switch are adapted to be transmitted wirelessly; and
the volume controller of the low volume switch is adapted to receive the wirelessly-transmitted conditions of the high volume switch and the low volume switch.

16. The improvement a defined in claim 11 wherein the portable radio has a body which is mounted upon the individual, the vehicle includes a cabin compartment having a headliner, and there is associated with the portable radio a microphone into which an individual speaks when using the portable radio in the talk mode, and the improvement is characterized in that
the microphone is mounted along the headliner of the cabin compartment of the vehicle and
The microphone is adapted to wirelessly transmit voice-carrying signals to the body of the portable radio for receipt thereby.
